(19) United States
(12) Patent Application Publication
(10) Pub. No.: US 2015/0156247 A1
(43) Pub. Date: Jun. 4, 2015

(54) Client-Side Bulk Uploader

(71) Applicants: Chase Hensel, San Francisco, CA (US); Ming Bai, Haidian District (CN); Hector Ouilhet, Mountain View, CA (US)

(72) Inventors: Chase Hensel, San Francisco, CA (US); Ming Bai, Haidian District (CN); Hector Ouilhet, Mountain View, CA (US)

(73) Assignee: Google Inc., Mountain View, CA (US)

(21) Appl. No.: 13/614,737

(22) Filed: Sep. 13, 2012

(51) Int. Cl. G06F 3/01; H04L 29/08; H04L 29/06

(52) U.S. Cl. CPC H04L 67/06; H04L 65/60; H04L 67/18

(57) ABSTRACT

Methods, systems and computer-readable storage mediums encoded with computer programs executed by one or more processors for providing client-side bulk uploading are disclosed. A selection of files is uploaded from a user device to a server over a network. The files are accessed to obtain metadata associated with each file. The metadata includes information by which the files are clustered and is accessible via a network. The files are clustered on the user device based on the metadata. The files of each cluster are associated with cluster information identifying the cluster to which a respective file belongs. The files, along with the clustering information, are uploaded, and one or more of the accessing, clustering and associating are performed in parallel with the uploading.

### BACKGROUND

The embodiments herein relate generally to bulk uploading of files.

A number of websites allow users to upload files, such as images, from their local computer over the Internet to the websites. However, uploading the files is often only part of the process. Often a user who is uploading images, for example, will want to rotate or caption the uploaded images. Conventional systems require the user to wait until all of the images are uploaded before allowing the user to rotate or caption the images. Uploading images however is a time-consuming process, and the more images a user desires to upload, the longer the user will have to wait in front of the computer for the images to upload prior to viewing or manipulating them in any way. For a website that seeks to incentivize or encourage users to upload images or other files, especially large numbers of files, users are often reluctant to do so because of the lengthy amount of time the user has to wait to complete the upload process.

### BRIEF SUMMARY

In general, the subject matter described in this specification may be embodied in, for example, a computer-implemented method. As part of the method, a selection of images is uploaded from a user device to a server over a network. The images are accessed to obtain metadata associated with each image. The metadata includes time metadata indicating when the image was captured. The images are clustered on the user device based on the time metadata. The images of each cluster are associated with cluster information identifying a cluster of images to which a respective image belongs and a geotag indicating a geolocation approximating where each image in a cluster was captured. The images, along with the clustering and the geotag information, are uploaded, and one or more of the accessing, clustering and associating are performed in parallel with the uploading.

Other embodiments include corresponding systems, apparatus, and computer programs, configured to perform the actions of the methods, encoded on computer storage devices. Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is an example diagram that illustrates usage of a client-side bulk uploading system, according to an embodiment.

FIG. 2 is a user-interface illustrating client-side clustering, according to an embodiment.

FIG. 3 is an example user-interface illustrating geotagging clusters, according to an embodiment.

FIG. 4 is an example user-interface illustrating a client-side preview, according to an embodiment.

FIG. 5 is a diagram illustrating a system that provides client-side bulk uploading, according to an embodiment.

FIG. 6 is a flowchart of a method for providing client-side bulk uploading, according to an embodiment.

FIG. 7 is a diagram of an example computer system that may be used in an embodiment.

### DETAILED DESCRIPTION

While the present disclosure makes reference to illustrative embodiments for particular applications, it should be understood that embodiments are not limited thereto. Other embodiments are possible, and modifications can be made to the embodiments within the spirit and scope of the teachings herein, and additional fields in which the embodiments would be of significant utility. Further, when a particular feature, structure, or characteristic is described in connection with some embodiments, it is submitted that it is within the knowledge of one skilled in the relevant art to affect such feature, structure, or characteristic in connection with other embodiments whether or not explicitly described.

Disclosed herein is a system for providing client-side bulk uploading of files. The system may operate in conjunction with any website, or other web service, that allows a user to upload files, such as, for example, image files, music files, video files, or other data files. A user may select which files the user desires to upload, and in contrast to conventional systems that require the user to wait until the files have completed uploading to manipulate the files, the system disclosed herein allows the user to manipulate the files while the files are uploading. For example, if uploading image files, the system may access the images on the user device (before they have been uploaded or while they are uploading), read the metadata of the images, and allow the user to view thumbnails of the images, group or sort the images, and add tags or captions to grouped or individual images. The system described herein may continually or concurrently upload the selected images (e.g., files) while the user groups, tags, or otherwise manipulates the images. The system described herein may then apply the image manipulations to the images or groups of images when they are uploaded.

Conventional uploading systems, as just referenced, require all of the files, such as image files, to finish uploading prior to allowing the user to access or manipulate the images. This requires the user to wait in front of his or her computer until all the files have completed uploading, and then take additional time to group or otherwise manipulate the files. Contrary to the system described herein, conventional uploading systems do not allow for the uploading of files and the manipulation of files to occur in parallel.

The system described herein may be used to upload and manipulate any number of files. For example, for a large number of files (e.g., hundreds or thousands of images), the system may automatically group or cluster the files based on the metadata in parallel while the system is uploading the files.

The system may then provide the grouped files, such as, for example, images to a user for further manipulations. For example, a user may apply a tag that indicates a location of image capture of an image or an entire group of images. Or, for example, the tag may indicate the item (or location of the item) that was captured in the image(s), especially for those images for which the photographed item is captured at a significant distance (e.g., using a long-range camera lens) from the actual location of image capture. After the user has finished tagging or otherwise manipulating the images, the embodiments of the system described herein may complete the uploading process and apply the user's tags to the uploaded images.

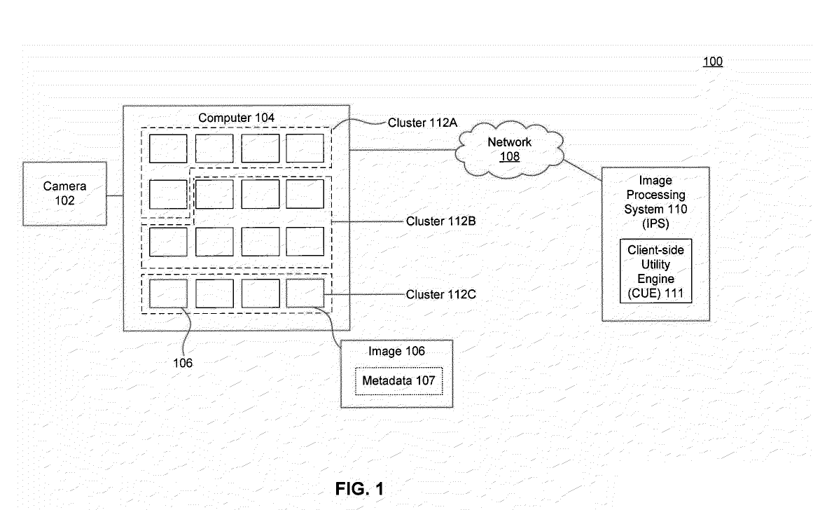

FIG. 1 is an example diagram that illustrates usage of a client-side bulk uploading system, according to an embodiment. FIG. 1 includes a camera 102, a computer 104, and images 106. Camera 102 may include any image capture device. For example, camera 102 may be a digital camera, mobile phone, tablet PC, webcam, or other device with a digital camera. Computer 104 may include any computing device. For example, computer 104 may be a computer (desktop, laptop, or tablet), mobile phone, or other device. In some embodiments, camera 102 and computer 104 may be the same device.

A user may connect camera 102 to computer 104 and download images 106 from camera 102 to computer 104. Images 106 may be transferred over a wire, network, Bluetooth, or other data transfer connection from camera 102 to computer 104. Images 106 may include any digital photograph(s) captured by camera 102. Though only 16 images 106 are shown in FIG. 1, other embodiments may include any number of images captured over different time periods, at different locations, or downloaded at different times over multiple download sessions. In some embodiments, as referenced above, images 106 may be any kind of files, and camera 102 may be any file-creation tool. For example, images 106 may be music files and camera 102 may be a music recording device.

Computer 104 is operatively connected to image processing system (IPS) 110 over network 108. Network 108 may include any communications network. For example, network 108 may be the Internet or other telecommunications network. IPS 110 may be, for example, any web service or website that accepts images 106 uploaded from computer 106 over network 108 to IPS 110. IPS 110 may include, for example, a photo-sharing website or a mapping website that allows a user to upload his/her own images 106.

IPS 110 may include a client-side utility engine (CUE) 111 that allows the user to simultaneously or concurrently upload and manipulate the images 106 being uploaded as described above. IPS 110 may allow a user to select which images 106 to upload, and while the images 106 are being uploaded, CUE 111 may allow the user to group, tag, or otherwise manipulate the uploading, uploaded, and queued for uploading images 106. Though located on a server (e.g., IPS 110), CUE 111 may provide utilities for a client (e.g., computer 104) to use while uploading files, such as images 106. The utilities provided by CUE 111, such as clustering and manipulating files, may be performed on the client while the files are uploading to a server, and are discussed in greater detail below. CUE 111 may then apply whatever modifications a user made (e.g., using the utilities) to the files after they have been uploaded to IPS 110.

In some embodiments, a user may connect to IPS 110 over network 108 by entering a uniform resource locator (URL) or other network address corresponding to IPS 110 in a web browser operating on computer 104. The user may then select an option to upload images or pictures to IPS 110. IPS 110 may then provide an option where the user may select which images the user desires to upload. Upon selection of images 106, the user may activate an “Upload Now” or other corresponding button that begins the upload process of images 106 from computer 104 to IPS 110 over network 108.

CUE 111 may allow the user to manipulate the images 106 after they have been selected for upload. CUE 111 may, for example, access images 106 (selected for uploading) stored on computer 104 and read metadata 107 corresponding to each image 106. Metadata 107 may include information about the image 106. For example, metadata 107 may include information about the date/time and/or place/item of image capture, thumbnail information, file type, file size, and any other information pertaining to images 106. In some embodiments, metadata 107 may be stored with images 106 and may be captured or recorded at or about the time of image creation/image capture by camera 102.

CUE 111 may cluster images 106 based on metadata 107. A user may then view and/or modify clusters 112 as created by CUE 111. CUE 111 may also allow a user to simultaneously tag an entire cluster 112 of images 106 by tagging the cluster 112. For example, a user may apply a geotag to a cluster 112 of images 106 that indicates where the images 106 were captured. Or, for example, the user may geotag only one image 106 of a cluster 112. CUE 111 may then apply the geotag to all the images 106 of the cluster 112. In the example of FIG. 1, images 106 may have been clustered into three different clusters 112A, 112B, and 112C. The clustering may be performed by CUE 111 based on any available metadata 107 for images 106, or may be performed or modified by a user.

In an example embodiment, the clustering may be performed by CUE 111 based on location metadata 107 corresponding to images 106. Based on location metadata, CUE 111 may determine the location of image capture for each image 106, group images 106 into clusters 112 based on that information, and tag images 106 of each cluster 112 with the corresponding location. For example, cluster 112A may include images captured in New York City, cluster 112B may include images captured at the Taj Mahal, and cluster 112C may include images captured at a particular amusement park. CUE 111 may also provide thumbnails of the images 106 and allow a user to manipulate images 106 (e.g., via their thumbnails) while images 106 are uploading. CUE 111 may then apply the corresponding cluster and manipulations to images 106 upon their upload to IPS 110.

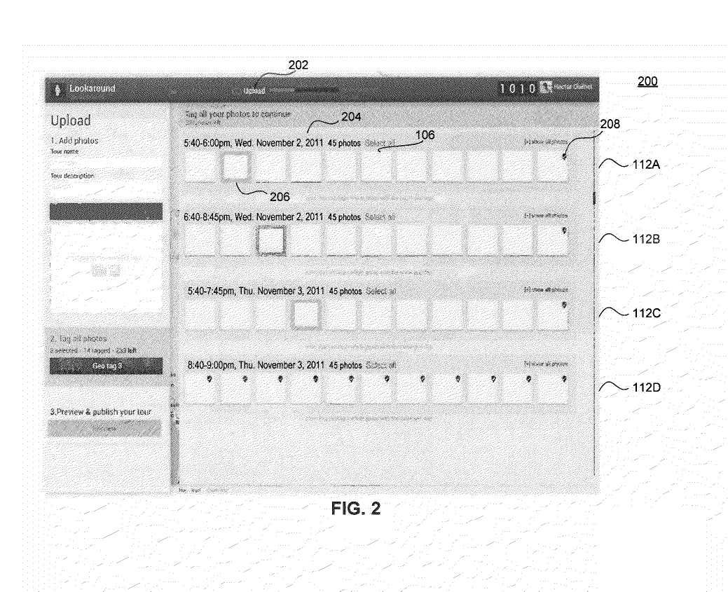

FIG. 2 is an example user-interface illustrating client-side image clustering, according to an embodiment. A status bar 202 indicates the upload progress of images 106 selected for upload. Screenshot 200 includes both images 106 that have been selected for upload (and are waiting to be uploaded), and images 106 that have already been uploaded, as indicated by marker 208.

Marker 208 may be an indicator (e.g., an icon) that indicates when an image 106 has been or is being uploaded. Images 106 without marker 208 are those images 106 selected for upload that have not yet been uploaded. Some embodiments may not distinguish between images 106 waiting for upload and images 106 that have been uploaded. Additionally, some embodiments may include an additional marker 208 indicating images that are waiting to be uploaded. As used herein, unless otherwise specified, images 106 will be used to refer to images 106 in any of the various states of upload (e.g., selected for and awaiting upload, currently being uploaded, or completed upload).

As shown, images 106 may be divided or separated into clusters 112A-D. For example, CUE 111 may divide images 106 into clusters 112 automatically based on metadata 107 that include, for example, the date/time of image capture as indicated by metadata 107 of images 106. CUE 111 may also apply a label 204 to clusters 112 that indicates the criteria (e.g., metadata 107) used to group images 106 into clusters 112. A user however may change label 204 to whatever label the user desires or otherwise deems appropriate for that group or cluster 112 of images 106.

Further to the previous example, CUE 111 may organize images 106 into clusters based on the date/time of image capture (e.g., as indicated by metadata 107). It may be that images 106 captured within a particular time interval or duration of each other are likely to have been captured near or about the same geographic location. Accordingly in some embodiments, CUE 111 may group images 106 that have been captured within a particular time interval or predetermined duration of each other into a single cluster 112. For example, images 106 captured within fifteen minutes of each other may be grouped into a first cluster 112A. If CUE 111 determines a particular image 106 was captured twenty minutes after any of the images 106 of cluster 112A, CUE 111 may organize that image 106 into a second cluster 112B along with other images 106 captured within fifteen minutes of the image 106 of second cluster 112B.

In other embodiments, CUE 111 may organize images 106 into clusters 112 based on location metadata, the date/time they were captured, or any other available metadata 107. A user may then adjust the clustering of images 106 as determined by CUE 111. For example, the user may drag and drop images 106 from one cluster 112 to another cluster 112 or add/remove images from particular clusters 112.

Each cluster 112 may include a cover image 206. Cover image 206 may be any image 106 selected from a particular cluster 112 to represent that particular cluster of images. As shown, in FIG. 2, cover images 206 may be indicated by a border around the selected images 106, indicating they are the album cover for the respective cluster 112 to which they belong. Upon completion of the upload process or for later viewing of images 106 on IPS 110, the user may be able to differentiate between or select from the various albums or clusters 112 based on their corresponding label 204 and cover image 206.

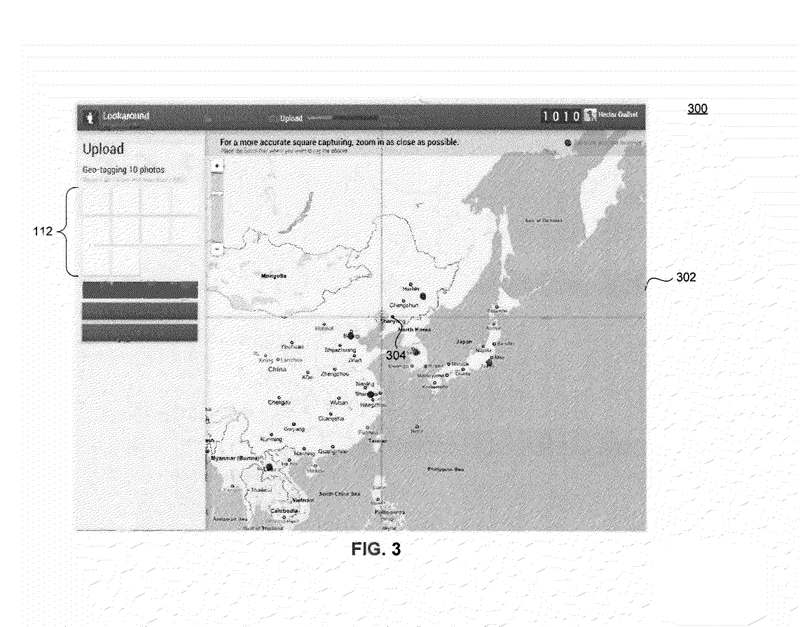

FIG. 3 is an example user-interface illustrating geotagging clusters, according to an embodiment. A user may use a map 302 to geotag clusters 112 of images 106. Grouping images 106 into clusters 112 as discussed above may allow a user to more easily or quickly apply a geotag 304 to images 106.

Geotag 304 may include, for example, an indication or identifier of a geolocation of image capture for a particular image 106. CUE 111 may allow a user to select geotag 304 for an entire cluster 112 of images 106, and then may apply the same geotag 304 to each image 106 of the cluster 112 rather than requiring the user to individually geotag each image (as may be required by conventional systems). If a user is uploading hundreds or thousands of images, rather than having to geotag each image 106 after the images have completed uploading, CUE 111 may allow the user to only geotag the various clusters 112 of images while images 106 are being uploaded.

As described above, in some embodiments, metadata 107 may include a geotag 304 for images 106 that may have been captured by camera 102. If metadata 107 includes geotag 304, then CUE 111 may group images 106 into clusters 112 based on geotag 304. CUE 111 may also automatically apply the geotag 304 data to all the images 106 belonging to the same cluster 112 as the geotagged image. The user may then verify the accuracy of the applied geotags 304 or clusters 112.

If metadata 107 does not include geotag 304 or if a user wishes to change geotag 304, the user may select a geolocation from map 302. In some embodiments, the user may select an area on map 302 of where the cluster 112 of images 106 was captured. For example, a user may identify where a cover image 206 of a cluster 112 was captured by zooming-in on map 302 and identifying the location of image capture. CUE 111 may then generate and apply a corresponding geotag 304 to all the images 106 of the cluster 112. Geotag 304 information may be applied or appended to metadata 107 for images 106.

In some embodiments, CUE 111 may request or require that the user select a geolocation within a particular radius of image capture, such as, for example, within 500 meters. Accordingly, map 302, as shown, may be a zoomed-out version of a map, allowing a user to select a country/city of image capture, and then may iteratively zoom in, until a more precise geolocation is selected by the user. Other embodiments however, may receive the geolocation differently. For example, other embodiments may not include map 302, or may include descriptions or images of particular locations that a user may select.

The geolocation or geotag 304 may include any indicator of the location of an image capture. For example, the geolocation may include a zip code, street address, street intersection, the name of a point-of-interest or other landmark, coordinates, or other indication of where cluster 112 of images was captured.

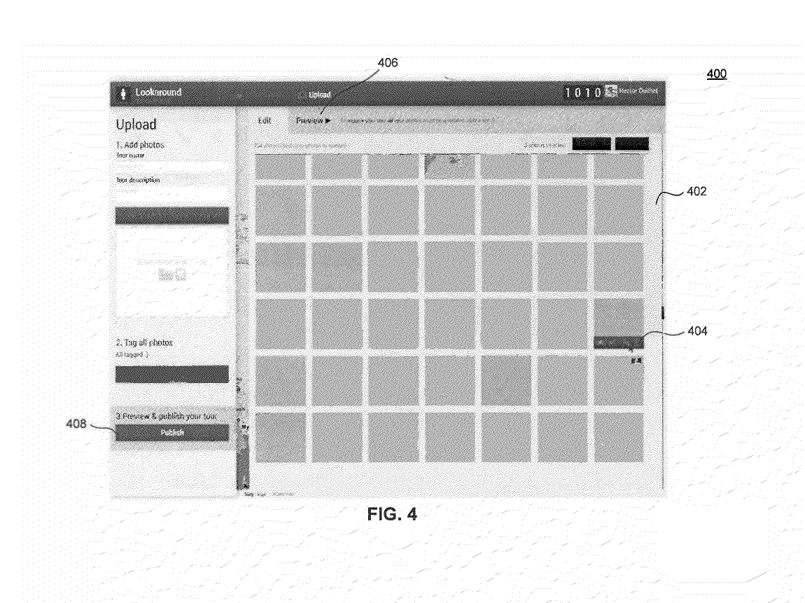

FIG. 4 is an example user-interface illustrating a client-side preview, according to an embodiment. User interface 400 may display images 106 which are selected for uploading or have already been uploaded. CUE 111 may generate a user interface 400 that includes thumbnails 402 of images 106.

As referenced above, metadata 107 of images 106 may include thumbnail information. After selection of images 106 for uploading, CUE 111 may read the thumbnail information from metadata 107 while images 106 are uploading. CUE 111 may then provide user interface 400 of the images 106 selected for upload.

User interface 400 may include the thumbnails 402 of the images 106 selected for upload. A thumbnail 402 may include a smaller or less-detailed version or representation of an image 106. From thumbnails 402, a user may manipulate or edit images 106 using editing tools 404.

In some embodiments, thumbnail 402 may include image 106, complete with all the details. For example, user interface 402 may load images 106 from the client-side and present images 106 as thumbnails 402 (e.g., complete images 106) via user interface 400. In other embodiments, thumbnails 402 may be reduced-sized versions of images 106. A user may then place a focus of an input device, such as a cursor, over a particular thumbnail 402 or select a particular thumbnail (e.g., with a mouse-click), in order to access or view the corresponding full image 106.

Editing tools 404 may allow a user to rotate, delete, caption, or otherwise edit an image 106 on a client-side or client device, whether or not the image 106 has been uploaded. For example, working from thumbnail 402, a user may determine that a particular image 106 that was captured vertically is displayed horizontally. The user may then rotate, flip, or delete the image 106 using editing tools 404. The changes may then be applied to the image 106 when it is uploaded. The user may also add a caption, perform red-eye correction, adjust the tint or other color options, or perform other manipulations to an image 106 from thumbnail 402.

In some embodiments, a user may select or be provided with an ordered preview 406 of images 106. Ordered preview 406 may include a particular ordering of images 106 as they will be displayed to a user viewing the cluster 112, or an album or tour of images 106. For example, a user who accesses IPS 110 may view map 302 and may be provided indicators which show geographic locations that correspond to images. The user may select a particular geographic location and be provided with a photo tour of images 106 from a particular cluster 112 as shown in user interface 400. The user may then scroll through the images 106 of the geographic location.

In some embodiments, a user uploading the images 106 may rearrange the order of the images 106 of a cluster 112 or tour. Upon completion of the manipulation or reordering of images 106, the cluster 112 of images 106 may be published by the user selecting publish button 408. Publish button 408 may send an indicator or signal to IPS 110 or CUE 111 that the user has completed the client-side processing of images 106. Then, for example, upon completion of the upload process CUE 111 may apply the clustering, manipulation, geotags, and ordering information to the uploaded images 106 and make the cluster 112 available to the public or specified other users for viewing.

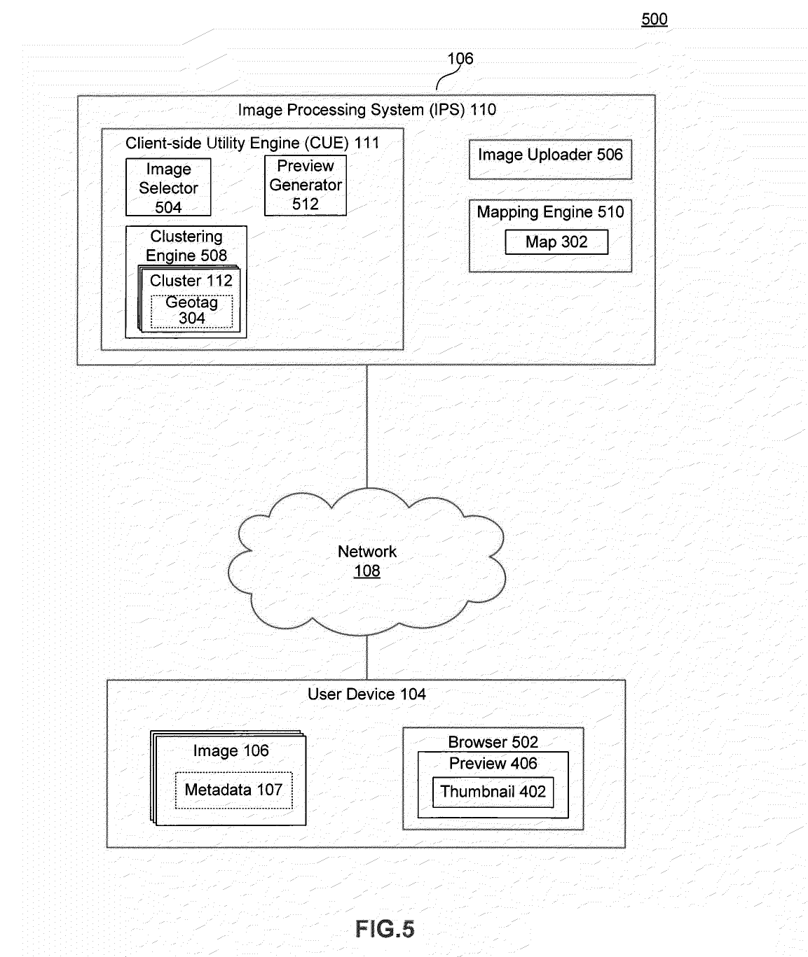

FIG. 5 is a diagram illustrating a system that provides client-side bulk uploading, according to an embodiment. A user may be operating a browser 502 to access websites or web services, such as IPS 110, over network 108. The user may desire or be requested to upload some images from user device 104 to IPS 110. For example, IPS 110 may be a mapping service that integrates user-provided images with pre-existing photographs to provide a more personalized view of areas of the world.

Using an image selector 504, the user may select images 106 to be uploaded to IPS 110. Image selector 504 may be any functionality that allows a user to select locally-stored images for uploading. Image selector 504 may allow a user to, for example, drag and drop images 106 to a particular location, enter the file names of images 106, or select images 106 in any other way from user device 104.

Upon selection of images 106, image uploader 506 may begin uploading the selected images 106 from user device 104 to IPS 110 over network 108. While image uploader 506 is uploading images 106, clustering engine 508 may read or otherwise access metadata 107 from the selected images 106 and organize or group images 106 into clusters 112. Metadata 107 may include exchangeable image file (EXIF) format data. EXIF data may be metadata 107 corresponding to particular image types, such as, for example, “.jpg” or “.tif” image files. In some embodiments, CUE 111 may also access metadata 107 for those images 106 for which EXIF data is available.

In some embodiments, clustering engine 508 may use an application programming interface (API) to access metadata 107 from images 106 stored on user device 104 over network 108. For example, the File API in hyper-text markup language (HTML) (e.g., in HTML 5 and beyond) may allow clustering engine 508 to access metadata 107. The File API represents file objects in web applications and allows for programmatic selection and accessing their data (e.g., metadata 107).

Though described herein as being used for accessing and uploading images 106, IPS 110 (e.g., system 500) in other embodiments may be used to access and upload different types of digital files. In an embodiment, IPS 110 may include a music processing system that accesses music files rather than images 106 on user device 104. IPS 110 may then access metadata 107 associated with the music files to provide previews (e.g., of songs, artists, album covers, etc.). A user may then group or sort the music files while they are being uploaded by IPS 110 over network 108. Other embodiments, may include any files that include metadata 107 that is accessible to IPS 110 over network 108 via an API (e.g., such as File API as just discussed). Other such files may include, but are not limited to, music, documents, or multi-media files (such as video clips).

Clustering engine 508 may organize clusters 112 on user device 104, and allow a user to reorganize or edit the clusters 112 as described above. The user may then apply geotags 304 to each cluster 112. For example, mapping engine 510 may provide map 302 allowing a user to select the approximate geolocation of image capture for each cluster 112 of images 106. Mapping engine 510 may further amend map 302 to include indicators indicating that clusters 112 of images are available at particular geolocations on map 302. For example, map 302 may include an indicator showing that a user has uploaded a cluster 112 of images for a particular location, such as Niagara Falls, Canada.

A preview generator 512 may then provide preview 406 of images 106 (on user device 104). Preview generator 512 may read thumbnail data from metadata 107 (e.g., using the File API) to generate preview 406 of thumbnails 402 for images 106. The user may then manipulate (e.g., rotate, flip, caption, etc.) thumbnails 402.

Image uploader 506 may be simultaneously uploading the selected images 106 from user device 104 while clustering engine 508, preview generator 512, and mapping engine 510 are executing. In some embodiments, the order in which clustering engine 508, preview generator 512, and mapping engine 510 operate or execute may vary.

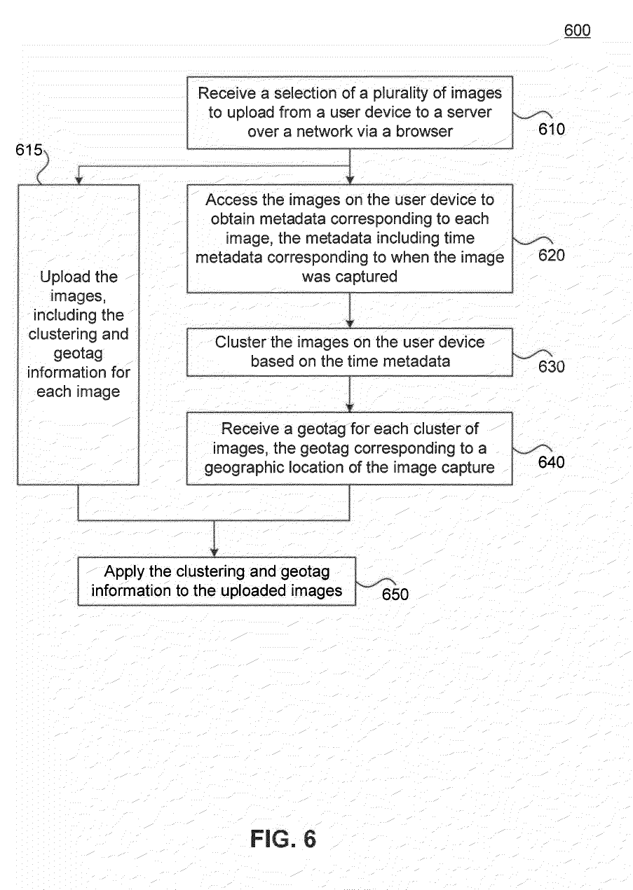

FIG. 6 is a flowchart of a method 600 for providing client-side bulk uploading. At stage 610, a selection is received of a plurality of images to upload from a user device to a server over a network via a browser. For example, using image selector 504, a user may drag-and-drop images 106 to upload to IPS 110 over network 108. IPS 110 may include any website or web service accessible via web browser 502. IPS 110 may include, for example, a photo-sharing or mapping system that allows users to upload and share images 106 captured at various geolocations. CUE 111 may begin uploading the selection of images 106, which may include any number of images 106.

At stage 615, the images and metadata, including the clustering and geotag information for each image are uploaded. For example, after selection of images 106 with image selector 504, image uploader 506 may begin the process of uploading images 106 from user device 104 over network 108. While images 106 are clustered, geotagged, and otherwise manipulated, image uploader 506 may continuously upload images 106. In an embodiment, images 106 may complete uploading prior to the completion of stages 620-640.

At stage 620, the images are accessed on the user device to obtain metadata corresponding to each image. For example, using a file API clustering engine 508 may access metadata 107 for images 106 stored on user device 104. Metadata 107 may include any information about images 106, including time metadata that indicates when each image 106 was captured.

At stage 630, the images are clustered on the user device based on the time metadata. For example, clustering engine 508 may automatically group images 106 into clusters 112 based on their time of image capture. In some embodiments, images 106 captured within a predetermined duration of each other, such as, for example, within thirty minutes or on the same day, may be grouped into the same cluster 112. In other embodiments, clustering engine 508 may use other metadata 107 to group images 107 into clusters, including, but not limited to geolocation metadata.

At stage 640, a geotag is received for each cluster of images, the geotag corresponding to a geographic location of image capture. For example, a user may select a location of image capture for a particular image (e.g., cover image 206) for a cluster 112 on map 302. Clustering engine 508 may then apply a geotag 304 corresponding to the selected location to all the images 106 belonging to the same cluster. In some embodiments, clustering engine 508 may receive geotags 304 for at least some images 106 from metadata 107.

At stage 650, upon completion of the clustering, geotagging, and other manipulation of images 106 (e.g., including thumbnails 402), image uploader 506 may apply the clustering, geotagging, and other manipulation information to the respective images 106 uploaded to IPS 110. In some embodiments, the clustering and geotag information may be applied to the respective images 106 as each respective image 106 is uploaded. In other embodiments, the clustering and geotag information may be applied to the respective images 106 after all the selected images 106 have completed uploading.

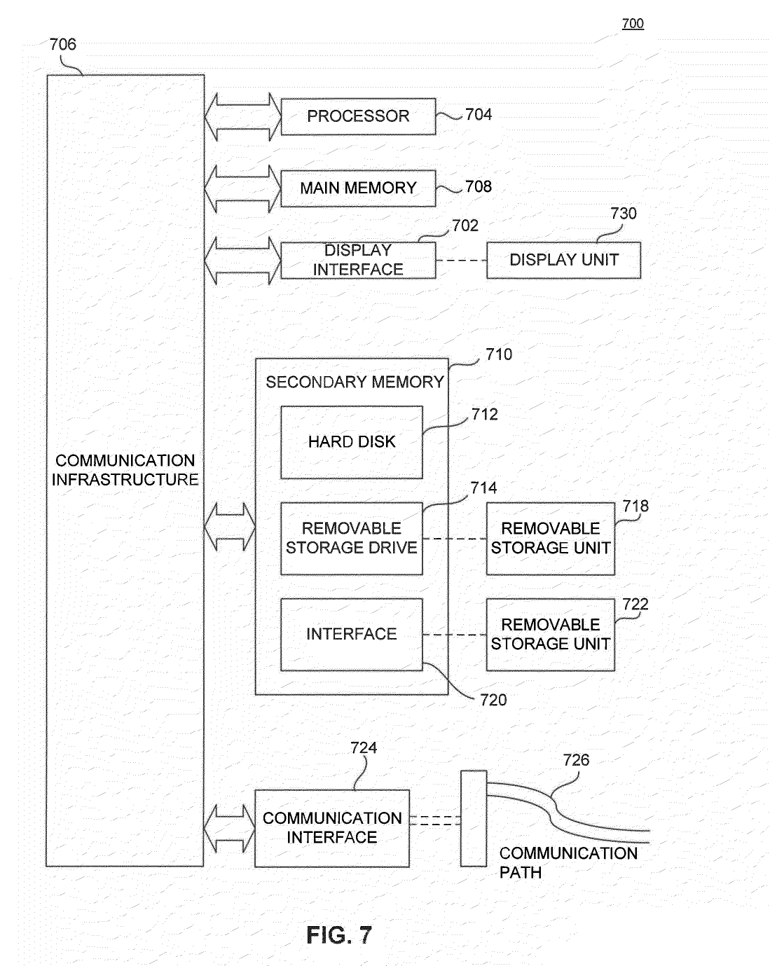

FIG. 7 illustrates an example computer system 700 in which embodiments as described herein, or portions thereof, may be implemented as computer-readable code. For example, system 500, including portions thereof, may be implemented in computer system 700 using hardware, software, firmware, tangible computer readable media having instructions stored thereon, or a combination thereof and may be implemented in one or more computer systems or other processing systems. Hardware, software, or any combination of such may embody any of the modules, procedures and components in FIGS. 1-6.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. The memory may include any non-transitory memory. A processor device may be a single processor, a plurality of processors, or combinations thereof. Processor devices may have one or more processor “cores.”

Various embodiments are described in terms of this example computer system 700. After reading this description, it will become apparent to a person skilled in the relevant art how to implement the embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 704 may be a single processor in a multi-core/multiprocessor system, such system may be operating alone, or in a cluster of computing devices operating in a cluster or server farm. Processor device 704 is connected to a communication infrastructure 706, for example, a bus, message queue, network, or multi-core message-passing scheme.

Computer system 700 also includes a main memory 708, for example, random access memory (RAM), and may also include a secondary memory 710. Main memory may include any kind of tangible memory. Secondary memory 710 may include, for example, a hard disk drive 712, removable storage drive 714. Removable storage drive 714 may comprise a floppy disk drive, a magnetic tape drive, an optical disk drive, a flash memory, or the like. The removable storage drive 714 reads from and/or writes to a removable storage unit 718 in a well-known manner. Removable storage unit 718 may include a floppy disk, magnetic tape, optical disk, etc. which is read by and written to by removable storage drive 714. As will be appreciated by persons skilled in the relevant art, removable storage unit 718 includes a computer readable storage medium having stored therein computer software and/or data.

Computer system 700 (optionally) includes a display interface 702 (which can include input and output devices such as keyboards, mice, etc.) that forwards graphics, text, and other data from communication infrastructure 706 (or from a frame buffer not shown) for display on display unit 730.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 may be in the form of signals, which may be electronic, electromagnetic, optical, or other signals capable of being received by communications interface 724. These signals may be provided to communications interface 724 via a communications path 726. Communications path 726 carries signals and may be implemented using wire or cable, fiber optics, a phone line, a cellular phone link, an RF link or other communications channels.

In this document, the terms “computer storage medium” and “computer readable medium” are used to generally refer to media such as removable storage unit 718, removable storage unit 722, and a hard disk installed in hard disk drive 712. Such media are non-transitory storage media. Computer storage medium and computer readable storage medium may also refer to memories, such as main memory 708 and secondary memory 710, which may be memory semiconductors (e.g. DRAMs, etc.).

Computer programs (also called computer control logic) are stored in main memory 708 and/or secondary memory 710. Computer programs may also be received via communications interface 724. Such computer programs, when executed, enable computer system 700 to implement embodiments as discussed herein. Where the embodiments are implemented using software, the software may be stored in a computer program product and loaded into computer system 700 using removable storage drive 714, interface 720, and hard disk drive 712, or communications interface 724.

Embodiments also may be directed to computer program products comprising software stored on any computer readable medium as defined herein. Such software, when executed in one or more data processing device, causes a data processing device(s) to operate as described herein. Embodiments may employ any computer readable storage medium. Examples of computer readable storage mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with some embodiments, it is submitted that it is within the knowledge of one skilled in the art to affect such feature, structure, or characteristic in connection with other embodiments whether or not explicitly described.

The Summary and Abstract sections may set forth one or more but not all exemplary embodiments as contemplated by the inventor(s), and thus, are not intended to limit the described embodiments or the appended claims in any way.

Various embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept as described herein. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described examples, but should be defined only in accordance with the following claims and their equivalents.

1. In a computer having a processor and a memory, a computer-implemented method, performed by the processor, that bulk uploads images from a user device over a network, the method comprising:
receiving, at a server, a selection of a plurality of images from a user device over a network;
obtaining metadata associated with each image, wherein the metadata includes time metadata indicating when the image was captured;
clustering, by one or more processors at the server, the images of the selection of images into one or more clusters based on at least the time metadata;
for each cluster, selecting by the one or more processors, a cover image to represent the cluster; and
associating, by the one or more processors, the images of each cluster with cluster information identifying a cluster of images to which the cover image belongs and a geotag indicating a geolocation approximating where the cover image was captured;
wherein one or more of the accessing, clustering, and associating are performed in parallel with the receiving.

2. The computer-implemented method of claim 1, wherein the receiving further comprises:
receiving the selection of a thousand or more images.

3. The computer-implemented method of claim 1, wherein associating each cluster of images with a geotag includes:
determining the geotag from the metadata associated with the cover image in a cluster, wherein the metadata includes a geolocation corresponding to a location where the cover image was captured; and
associating the determined geotag with all of the images of the cluster that includes the cover image.

4. The computer-implemented method of claim 1, wherein the accessing, clustering, and associating are all performed in parallel with the receiving.

5. The computer-implemented method of claim 1, wherein obtaining the metadata includes:
initiating uploading of the selection of images;
wherein the selected images include both images that have been uploaded and images waiting to be uploaded from the user device.

6. The computer-implemented method of claim 1, further comprising:
applying the geotag information to one or more received images.

7. The computer-implemented method of claim 6, further comprising:
positioning an indicator on a map based on the geolocation of the geotag associated with the cover image.

8. The computer-implemented method of claim 1, wherein associating each cluster of images with a geotag includes receiving a geotag based, at least in part, on user input, wherein the geotag is within five hundred meters of the geolocation of at least one image in a cluster.

9. The computer-implemented method of claim 1, wherein clustering the images includes arranging the images into one or more groups based on the time metadata associated with each image.

10. The computer-implemented method of claim 1, wherein clustering the images includes:
determining, based on the time metadata, whether a first image and a second image were captured within a predetermined duration; and
when the first and second images were captured within the predetermined duration, arranging the first image and the second image in a same cluster.

11. The computer-implemented method of claim 1, further comprising:
obtaining thumbnails of the images based on the metadata associated with each respective image; and
providing the thumbnails of the images for display on the user device prior to a completion of the uploading.

12. The computer-implemented method of claim 11, further comprising:
generating a preview of a photo tour from the images in a cluster, wherein the photo tour is of a geolocation that corresponds to the geotag associated with the cluster, and wherein the preview includes an arrangement of the thumbnails of each image in the cluster.

13. A system that bulk uploads images from a user device over a network, the system comprising one or more processors implementing:
an image selector configured to receive a selection of a plurality of images to upload from a user device to a server over a network via a browser;
a clustering engine configured to:
cluster the selected images on the user device into one or more clusters based on metadata corresponding to each of the selected images, the metadata including time metadata indicating when the image was captured,
for each cluster, select a cover image to represent the cluster, and
associate the images of each cluster with cluster information identifying a cluster to which the cover image belongs;
a mapping engine configured to receive a geotag for each cluster, the geotag corresponding to a geolocation of at least the cover image in the cluster; and
an image uploader configured to upload the selected images and clustering information, and geotag information for each image, in parallel with the clustering as performed by the clustering engine.

14. The system of claim 13, wherein the mapping engine is configured to provide a map for display, wherein the mapping engine is configured to receive the geotag based on a selection of a geolocation on the map.

15. The system of claim 14, wherein the mapping engine is configured to provide an indicator representing a correspondence between a geotagged cluster and corresponding geolocation on the map, wherein upon a subsequent rendering of the map on the user device the map includes the indicator at the geolocation.

16. The system of claim 13, wherein the one or more processors further implement:
a preview generator configured to provide a preview of the selected images being uploaded, wherein the preview comprises thumbnails of the selected images generated based on the metadata, and wherein the preview is provided in parallel with the uploading by the image uploader to a server.

17. The system of claim 13, wherein the clustering engine is configured to
cluster the images into one or more clusters based on the time metadata; and
automatically geotag one or more of the clusters based on location metadata of at least the cover image of a corresponding cluster, the location metadata indicating a geolocation of the image capture.

18. The system of claim 13, wherein the clustering engine is further configured to receive a new clustering of the clustered images based upon a selection as received from a user operating the user device, and wherein the clustering engine is configured to apply the new clustering of the images to the images upon a completion of the uploading by the image uploader.

19. The system of claim 13, wherein the image uploader is configured to
upload a particular one of the selected images prior to the mapping engine receiving the geotag for the cluster to which the particular selected image belongs, and
update the geotag for an uploaded particular selected image based on the receipt of the geotag by the mapping engine.

20. A non-transitory computer readable medium storing code thereon for bulk uploading images from a user device over a network, the code, when executed by one or more processors, causing the one or more processors to:
upload a selection of a plurality of images from a user device to a server over a network via a browser;
access the images on the user device via the browser to obtain metadata associated with each image, the metadata including time metadata indicating when the image was captured;
cluster the images on the user device into one or more clusters based on the time metadata corresponding to each image;
select, for each cluster, a cover image to represent the cluster;
associate each cluster of images with a geotag corresponding to a geolocation of the cover image; and
provide a preview of the geotagged clusters of images;
wherein the upload of the images from the user device to the server is performed in parallel with the accessing, the clustering, and the providing of the preview as performed by the one or more processors.

21. The computer readable medium of claim 20, wherein executing the code causes the one or more processors to:
determine whether the images on the user device include exchangeable image file format (EXIF) metadata; and
cluster and upload only those images with EXIF metadata.

22. The computer readable medium of claim 21 wherein executing the code causes the one or more processors to:
access the images using a file application programming interface (API) of a hyper-text markup language (HTML).

23. In at least one computer having at least one processor and one memory, a computer-implemented method, performed by the at least one processor, that bulk uploads files from a user device over a network, the computer-implemented method comprising:
uploading a selection of a plurality of files from a user device over a network;
accessing the selection of files on the user device to obtain metadata associated with each file, wherein the metadata includes information by which the files are clustered, and wherein the metadata is accessible from the user device via the network without uploading the corresponding file;
clustering the selected files into one or more clusters based on the metadata;
for each cluster, selecting a cover file to represent the cluster; and
associating the files of each cluster with cluster information that identifies the cluster to which a respective file belongs and with location information of the cover file;
wherein one or more of the accessing, clustering, and associating are performed in parallel with the uploading.

24. The computer-implemented method of claim 23, wherein the clustering comprises:
providing the selected files on the user device for clustering; and
determining the cluster information based on the clustering of the selected files on the user device.
